(19) United States
(12) Patent Application Publication
(10) Pub. No.: US 2018/0245754 A1
(43) Pub. Date: Aug. 30, 2018

(54) Linear LED Lighting with Built-In Light Modifiers

(71) Applicant: Elemental LED, Inc., Emeryville, CA (US)

(72) Inventors: Steven W. Gensler, San Jose, CA (US); Russell Petersen, Alameda, CA (US)

(73) Assignee: Elemental LED, Inc.

(21) Appl. No.: 15/444,206

(22) Filed: Feb. 27, 2017

(51) Int. Cl. F21S 4/28; F21V 5/04; F21V 3/04; F21V 5/02; F21V 19/00

(52) U.S. Cl. CPC F21S 4/28; F21V 5/04; F21V 3/049; F21Y 2115/10; F21V 19/0025; F21V 3/0472; F21V 5/02

(57) ABSTRACT

Linear LED lighting is disclosed. The linear LED lighting includes a flexible PCB on which a number of LED light engines are disposed, typically at a regular pitch. The PCB is surrounded by a flexible, translucent covering, which may be a plastic, such as poly(vinyl chloride) (PVC). The covering has a light modifying property or effect, typically lensing, diffusion, or a combination of the two. For example, the covering may form a plano-convex or plano-concave lens, or it may form a prism. Additionally or alternatively, the coating may include an additive that diffuses the light, or have a coating with that additive that does so. Exemplary additives include beads, microspheres, fibers, or other particles of glass and silica, as well as plastics like poly(methyl methacrylate), polycarbonate, and poly(ethylene terephthalate). In some embodiments, the covering may be mechanically modified to diffuse light, e.g., by an impressed pattern or by abrasion.

### BACKGROUND OF THE INVENTION

### 1. Field of the Invention

In general, the invention relates to linear LED lighting, and more specifically, to linear LED lighting with built-in light modifiers.

### 2. Description of Related Art

Over the last decade, lighting based on light-emitting diodes (LEDs) has become dominant in the lighting industry, and is widely used in both residential and commercial installations. LED-based lighting has a number of advantages compared with legacy incandescent and fluorescent lighting, including high efficiency and low power draw, relatively low operating temperatures, and, with some models, selectable color and controllable color temperature.

For most commercial and residential applications, two major types of LED-based lighting are used: bulb-type lamps and linear lighting. Bulb-type lamps are intended as direct replacements for incandescent light bulbs, typically have a shape similar to the type of bulb they are intended to replace, have a traditional socket to connect to a fixture and draw power, and are usually constructed to produce roughly the same light output as the bulbs they are intended to replace. Linear lighting is somewhat different—it usually includes a number of LEDs arranged at a regular spacing or pitch along a printed circuit board (PCB). That PCB may be rigid, made, for example, of FR4 composite, or it may be flexible, made, for example, of Mylar. In either case, the PCB usually has the form of a thin strip, although other shapes and sizes are possible. The amount of light produced by a strip of linear lighting depends on the properties of each LED, the pitch of the LEDs, and the total length of the strip, and is usually expressed in units of light intensity per unit length.

Linear lighting may be either low voltage or high voltage. In low-voltage variants (typically designed to operate at or below about 50V), the PCB may simply be exposed, with no surrounding electrical insulation. However, high-voltage variants are usually enclosed. One type of high-voltage linear lighting is shown in U.S. Pat. No. 9,509,110, the contents of which are incorporated by reference in their entirety. In the type of linear lighting disclosed in the '110 patent, the PCB with the LEDs is enclosed within a clear, electrically insulating covering. Power and ground leads traverse the length of the PCB within the insulating covering.

One of the major advantages of linear lighting is its versatility. Alone, it can serve as accent lighting or task lighting, often in locations where it would be difficult to install traditional lighting fixtures. Placed in an appropriate extrusion and covered with a diffuser, it can serve as primary room lighting, replacing legacy fluorescent fixtures in offices. Properly electrically insulated and encapsulated, it can be used even in outdoor and wet locations.

Despite myriad advantages, linear lighting does have some drawbacks. For example, unmodified, the light from a strip of linear lighting appears as a number of discrete points of light. This is acceptable for many applications, but not all. The usual solution is to place the lighting in an extrusion and cover it with a diffuser, which, again, is acceptable for many applications, but not all.

### SUMMARY OF THE INVENTION

One aspect of the invention relates to linear LED lighting. The linear LED lighting includes a flexible PCB on which a number of LED light engines are disposed, typically at a regular pitch. The PCB is surrounded by a flexible, translucent covering, which may be a plastic, such as poly(vinyl chloride) (PVC). The covering has a light modifying property or effect, typically lensing, diffusion, or a combination of the two. For example, the covering may form a plano-convex or plano-concave lens, or it may form a prism. Additionally or alternatively, it may include an additive that diffuses the light, or have a coating that does so; or it may be mechanically modified to diffuse light, e.g., by an impressed pattern or by abrasion.

Other aspects, features, and advantages of the invention will be set forth in the following description.

### BRIEF DESCRIPTION OF THE DRAWING FIGURES

The invention will be described with respect to the following drawing figures, in which like numerals represent like features throughout the drawings, and in which:

FIG. 1 is a perspective view of a strip of linear LED lighting with a covering that forms a plano-convex lens according to one embodiment of the invention;

FIG. 2 is a cross-sectional view of the strip of linear LED lighting of FIG. 1, taken through Line 2-2 of FIG. 1;

FIG. 3 is a sectional view, similar to the view of FIG. 2, of a strip of linear LED lighting according to another embodiment of the invention;

FIG. 4 is a sectional view, similar to the view of FIG. 2, of a strip of linear LED lighting with a covering that forms a plano-concave lens according to another embodiment of the invention;

FIG. 5 is a sectional view, similar to the view of FIG. 2, of a strip of linear LED lighting with a covering that forms another type of plano-concave lens according to another embodiment of the invention;

FIG. 6 is a transverse sectional view, similar to the view of FIG. 2, of a strip of linear LED lighting having a covering with a longitudinally-patterned surface;

FIG. 7 is a longitudinal sectional view of the strip of linear LED lighting of FIG. 6, illustrating that the covering has a transversely-patterned surface as well;

FIG. 8 is a sectional view, similar to the view of FIG. 2, of a strip of linear LED lighting with a diffusing or dispersing additive according to another embodiment of the invention;

FIG. 9 is a sectional view, similar to the view of FIG. 4, of a strip of linear LED lighting with a diffusing or dispersing coating according to another embodiment of the invention;

FIG. 10 is a sectional view, similar to the view of FIG. 9, of a strip of linear LED lighting with another type of diffusing or dispersing coating according to yet another embodiment of the invention;

FIG. 11 is a sectional view, similar to the view of FIG. 10, of a strip of linear LED lighting according to a further embodiment of the invention;

FIG. 12 is a sectional view of a strip of linear LED lighting that has both lensing and diffusing light-modifying properties, with a plano-concave lens overtop a diffusing layer;

FIG. 13 is a sectional view of a strip of linear LED lighting that has a covering with a single prism; and

FIG. 14 is a sectional view of a strip of linear LED lighting that has a covering with a double prism.

### DETAILED DESCRIPTION

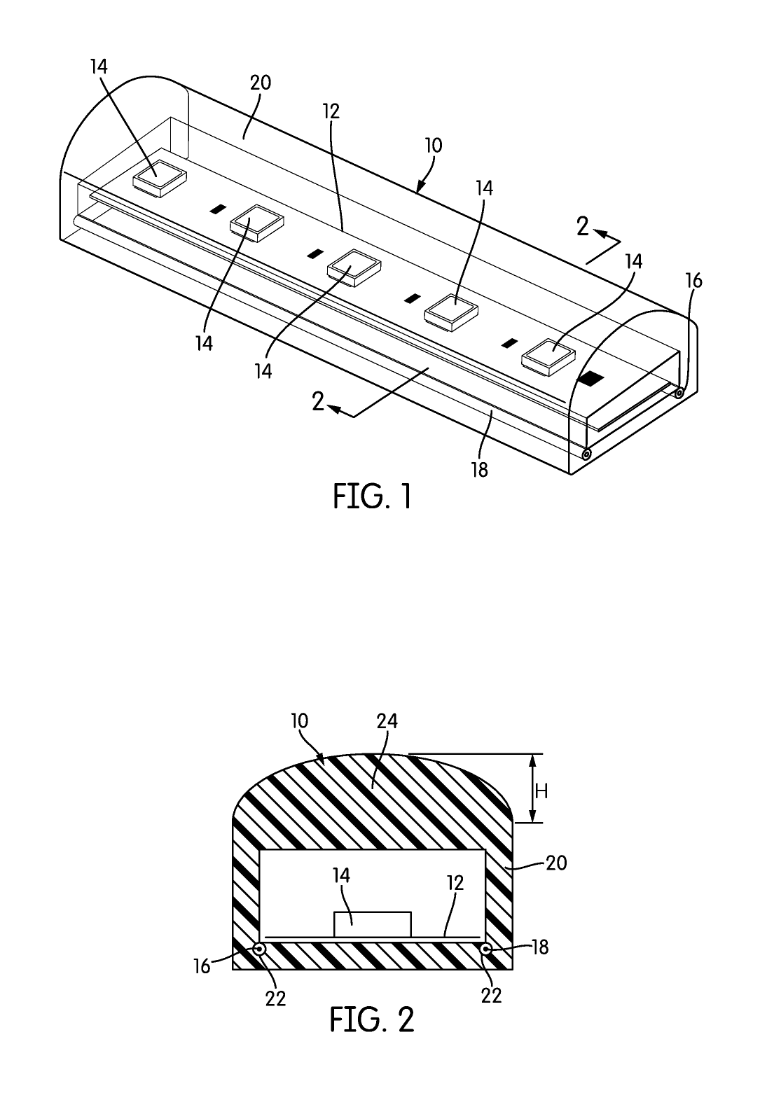

FIG. 1 is a perspective view of a strip of linear LED lighting, generally indicated at 10. The linear lighting 10 comprises a printed circuit board (PCB) 12 on which a number of LED light engines 14 are disposed, spaced at a regular pitch. The linear lighting 10 operates at high voltage. On the sides of the PCB 12, power and ground leads 16, 18 extend the full length of the linear lighting 10. The power and ground leads 16, 18 typically carry the voltage at which the linear lighting 10 is designed to operate, which may be, for example, 110-120V, 220-240V, or 277V of alternating current (AC). The entire assembly is enclosed within a flexible casing or covering 20, typically made of a clear plastic, such as poly(vinyl chloride) (PVC).

Typically, the PCB 12 would be flexible, made, for example, of a material such as Mylar. Of course, that is not the only material from which the PCB 12 may be made—in sufficiently thin section, many materials possess the kind of flexibility that is useful in the linear lighting 10, including thin sections of FR4 (i.e., glass fiber composite), aluminum, polyimide, silicon, gold, carbon nanotubes, and any number of plastics. In the linear lighting 10, the LED light engines 14 are mounted on a first layer, and there is at least one other layer that carries power and signals, although any number of layers may be included in the PCB 12, and those layers may be designed in any manner.

Depending on the application, the LED light engines 14 may be bare LEDs, but in most embodiments, each LED light engine 14 comprises one or more individual LEDs, packaged together with an element or elements that modify or diffuse the light produced by the LEDs. The packages of most LED light engines 14 include a phosphor to modify the color or color temperature of the light. For purposes of this description, it will be assumed that the LED light engines 14 are configured to accept low voltage DC. The LED light engines 14 may be single color, red-green-blue (RGB) selectable color, or contain any other type of LEDs.

While a short section of the linear lighting 10 is shown in FIG. 1, it should be understood that the linear lighting 10 can be made and sold in great lengths, such that the linear lighting 10 is usually much, much longer than it is wide. For example, as illustrated in a high-voltage configuration with an input voltage of 110-120 VAC, the linear lighting 10 may have a typical length as great as 50 meters, with a total width on the order of about 1.6 cm.

In embodiments of the invention, the casing or covering 20 is adapted to modify the light emitted by the LED light engines 14. As will be explained below in more detail, the covering 20 may be adapted, in various embodiments, to provide lensing effects, diffusing effects, or both. “Lensing,” as the term is used here, refers to effects typically caused by lenses, such as convergence of rays of light, divergence of rays of light, and changing the direction of rays of light. “Diffusion” and “diffusing effects,” as those terms are used here, refers to the spreading or scattering of transmitted or reflected beams of light, typically by transmission through a non-uniform medium or refraction at a non-uniform surface or interface. In addition to lensing and diffusion, the covering 20 may modify the direction of the light, as will be described below.

This is significantly different from the traditional arrangement, in which the covering is merely designed to transmit the light emitted by the LED light engines 14. Modifying the light from the LED light engines 14 using the covering 20 may allow the linear lighting 10 to have a more uniform appearance and to provide more uniform light. In applications where the linear lighting 10 is intended to be used with a diffuser or other external optical modifiers, a covering 20 that is adapted to modify the light close to the LED light engines 14 may mean that those external optical modifiers can be less complex or placed at a more advantageous distance from the linear lighting 10. In some cases, a covering like covering 20 with built-in optical modifier(s) and any additional external optical modifiers may work together synergistically.

As will be described below in more detail, the covering 20 of FIG. 1 acts as a lens. This can be seen more clearly in FIG. 2, a cross-sectional view taken through Line 2-2 of FIG. 1. As shown in FIG. 2, the covering 20 surrounds the PCB 12, providing openings 22 for the power and ground leads 16, 18. Overall, the thickness of the covering 20 is sufficient to provide electrical insulation for the voltage at which the linear lighting 10 operates. A thickness on the order of 1-3 mm, e.g., 2 mm, may be suitable in at least some embodiments, although the actual thickness may vary based on a number of factors, including regulatory requirements for electrical insulation, the voltage at which the linear lighting 10 operates, and the elastic modulus or flexibility of the material, among others. While parts of this description may assume that the linear lighting 10 operates at high voltage, embodiments of the invention may operate instead at low voltage, in which case the covering may not need to serve as electrical insulation. In that case, any suitable thickness of covering 20 may be used.

The definitions of the terms “high voltage” and “low voltage” vary depending on which authority one consults. For purposes of this description, “high voltage” should be construed to refer to voltages over about 50V. It should be understood that when this description refers to AC voltages, the voltages given are the root mean square (RMS) voltages. The peak voltages may be higher. For example, standard 120V AC may have peaks of up to about 170V.

In the illustrated embodiment, the sides and bottom of the covering 20 are generally straight and the overall shape of the covering 20 is generally rectilinear. However, the upper portion of the covering 20, extending overtop the LED light engines 14, forms a plano-convex lens 24. That is, the top outer surface of the covering 20 is outwardly curved, while the inner surface of the covering 20 is flat. This causes the light emitted by the LED light engines 14 to pass through the lens 24, focus at a point defined by the properties of the lens 24, and scatter outward from that point. It should be understood that while the traditional plano-convex lens is round, a typical strip of linear lighting 10 according to embodiments of the invention will have the cross-section shown in FIG. 2 over its entire length. Thus, the focus of the light could more properly be said to be along a particular focal line, rather than a point.

The optical properties of the lens 24 will depend on the optical properties of the material of which the covering 20 is made. In this embodiment, the covering 20 would typically be translucent. The material of the covering would typically also have a higher refractive index than that of air. For example, PVC, a typical material for a covering 20 of this type, has a refractive index in the range of about 1.54, depending on the particulars of the material. The details of designing lenses of this type are well known to those of skill in the art, and the basic features of the lens 24, including its focal length, can be readily calculated using, e.g., the lens maker's equation.

In one embodiment, for example, the total width of the linear lighting 10, fully enclosed by the covering 20, is on the order of about 1.6 cm, and the covering itself has a basic thickness of about 2 mm. In this case, the lens 24 may have a peak height, beyond the basic thickness, of, e.g., about 1-10 mm, indicated as H in FIG. 2, although many embodiments may be in the range of 1-5 mm. For example, a height H of about 3 mm may be suitable in at least some embodiments.

While this portion of the description refers to the covering 20 having a lens 24, it should be understood that the lens 24 need not be optically perfect or without aberration in order to be useful in linear lighting 10. In most embodiments, typical tolerances for molding the covering of linear lighting can be used. Only in particular embodiments in which the covering 20 must have a precise focal point to work with a particular external optical modifier or in a particular application might more exacting shapes and tolerances be used.

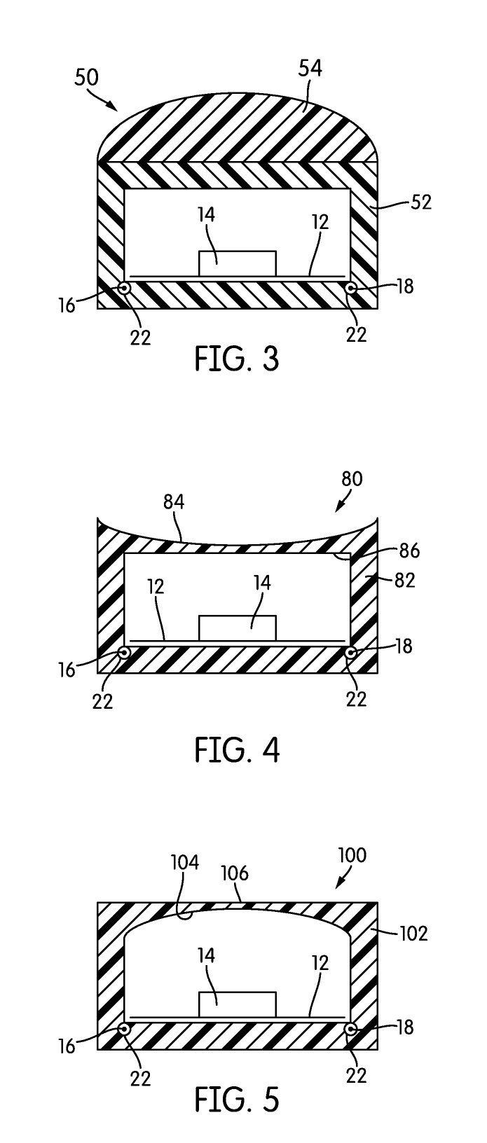

In the embodiment of FIGS. 1 and 2, the covering 20 and lens 24 are unitary, contiguous, and made of the same material. This may be preferable if the material of the covering 20 has an appropriately high index of refraction and is otherwise an appropriate material for the lens. However, the lens 24 may be formed separately from the covering 20. As an example of this, FIG. 3 is a sectional view, similar to the view of FIG. 2, of a strip of linear lighting, generally indicated at 50. In the linear lighting 50, the covering 52 and the lens 54 are distinct layers. They may be formed by co-extruding the covering material and the lens material, or by extruding the lens layer 54 overtop of the covering 52. In these scenarios, it is assumed that the covering 52 and the lens 54 layers will bond together at high temperature.

If the covering 52 and lens 54 will not bond together in an extrusion or co-extrusion process, or if there is some other reason why co-extrusion is disadvantageous, the covering 52 and the lens 54 could be extruded or otherwise manufactured separately and adhered together in a finishing step using an appropriate, optically-transmissive adhesive, such as a UV-cured optical adhesive. Additional curing or annealing steps may be used to relieve residual stresses in the layers 52, 54.

Separating the covering 52 and the lens 54 portions would allow the covering 52 to be made from a different material than the lens 54. This would allow the lens 54 to be made, for example, of a material with a higher refractive index than the material of which the covering 52 is made. The properties of any lens 24, 54, including its focal length, may be chosen to complement the characteristics of an extrusion and diffuser in which the linear lighting 10, 50 is intended to be used.

FIGS. 1-3 show a covering 20, 52 that includes a plano-convex lens. Of course, other types of lenses may be used. FIG. 4 is a cross-sectional view, similar to the views of FIGS. 2 and 3, of linear lighting according to another embodiment of the invention, generally indicated at 80. The linear lighting 80 has a covering 82, again made of a transparent plastic material, such as PVC. The upper surface 84 of the covering 82 is concave, and serves as a plano-concave lens, as the inner surface 86 of the covering 82 in that region is planar or substantially so. As compared with a plano-convex lens, a plano-concave lens may spread the light leaving the covering 82 more.

As can be seen in FIG. 4, the upper surface 84 of the covering 82 may have relatively sharp corners where the surface transitions to concave. In some cases, sharp corners may pose manufacturing difficulties. Therefore, the cross-section of the covering for a plano-concave lens may be somewhat different for manufacturing purposes. FIG. 5 is a cross-sectional view of linear lighting 100 according to another embodiment of the invention. The linear lighting 100 has a covering 102, again made of a transparent plastic material, such as PVC. In the linear lighting 100, the inner, upper edge 104 of the covering 102 facing the LED light engines 14 is concave. The outer surface 106 is planar, forming a plano-concave lens that is inverted in orientation compared with the lens 84 of FIG. 4. In other words, the concavity of the lens is facing toward the PCB 12 in the illustration of FIG. 4.

As was noted briefly above, in some embodiments, the covering of the linear lighting may have diffusing properties. As will be described below, “diffusing” can encompass a wide range of techniques and structures. It may, for example, involve using non-planar, patterned, or uneven surfaces on the covering to refract and scatter the light at the interface between the covering and the ambient air. Additionally or alternatively, it may involve making the covering into a non-homogeneous medium with particles or other elements that refract and scatter the light as it moves through the covering.

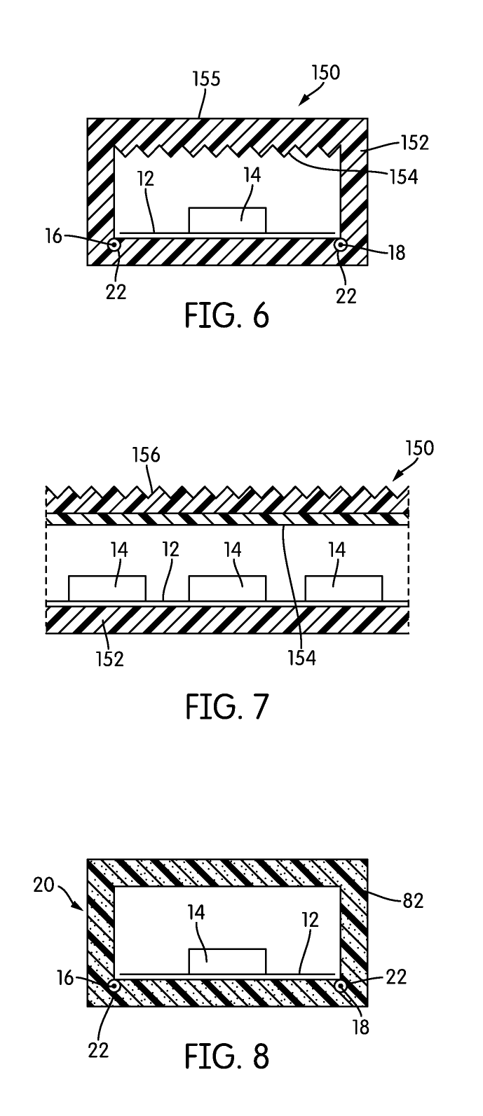

For example, FIG. 6 is a cross-sectional view, similar to the views of FIGS. 2-5, illustrating linear lighting, generally indicated at 150, with a covering 152. The covering 152 is made of a transparent plastic material, such as PVC, like the other embodiments. In the covering 152, the inner surface 154, facing the LED light engines 14, is patterned with a sawtooth pattern. This can be done, for example, by using a roller or worm with the appropriate pattern. In many cases, it may be done during the extrusion process, although in some cases, a pattern may be added later by cold-working the covering 152 (i.e., by impressing a pattern or cutting the covering 152 to form a pattern). If a longer-duration exposure to the pattern is necessary, or if it is desirable to expose more area to the pattern at one time, the pattern could be formed by moving an endless belt with projections that will form the pattern over the covering 152.

As can be appreciated from the transverse cross-section of FIG. 6, the sawtooth pattern of the inner surface 154 runs longitudinally, i.e., along the length of the linear lighting 150. In embodiments of the invention, such a pattern may run longitudinally, transversely, or in both directions. FIG. 7 is a longitudinal cross-section of the linear lighting 150. As shown in FIG. 7, the outer surface 156 also has a sawtooth pattern. Thus, one pattern on the inner surface 154 runs longitudinally and a second pattern runs transversely along the outer surface 156. The two surfaces 154, 156 may have the same pattern or different patterns.

The patterns shown in FIGS. 6 and 7 may be implemented at any scale, and may be smaller or larger than what is illustrated. Moreover, while sawtooth patterns have been shown, the patterns that are used in any given embodiment may vary widely. For example, a pyramidal pattern may be embossed in the covering. In other embodiments, a pattern that involves a grid of micro-lenses may be used. This kind of pattern would have, for example, a grid of small plano-convex or plano-concave lenses. These sorts of patterns are frequently used on translucent PMMA or polycarbonate diffuser panels for fluorescent fixtures, and could be adapted to the covering of an LED strip light.

In addition to using a mechanical roller or worm to produce a pattern in the covering that will diffuse light, the covering may be mechanically abraded, etched, or otherwise modified after manufacture to produce a surface that will diffuse light. For example, after manufacture, the outer surface 155 of a covering like covering 152 of FIG. 6 may be sand blasted to produce a rougher surface that will act to diffuse the light. If a covering like covering 152 is to be mechanically abraded, it may be made slightly thicker than a comparable covering, so that the abrasion does not bring the covering below a minimum acceptable thickness or compromise other functions of the covering, like electrical insulation. Such a covering should generally be abraded only to a relatively shallow depth, such that doing so does not create a mechanical stress concentrator/crack initiator that will cause the covering 152 to crack and fail when it is flexed. For that same reason, any pattern impressed into the covering 152 may be slightly rounded at its root, in order to avoid stress concentrators that could cause failure in flexure.

Other structures and elements may be used to diffuse the light as well. FIG. 8 is a sectional view similar to the views of FIGS. 2 and 3 of a piece of linear lighting, generally indicated at 200, according to another embodiment of the invention. The linear lighting 200 has a covering 202. In contrast to the embodiments described above, the covering 202 does not have a modified shape; rather, it is generally rectangular. The covering 202 is made of a typical material, for example, PVC, but in addition to that material (and conventional additives, such as plasticizers, UV-retardants, etc.), the covering 202 contains an additive that has a light-modifying effect when added to the covering 202.

In most embodiments, the desired light-modifying effect is diffusion—the scattering of the light emitted by the LED light engines 14 and elimination of glare from the LED light engines 14. Additives suitable for this purpose may include such things as glass, poly(methyl methacrylate) (PMMA), or polycarbonate microspheres or beads, or short, randomly-oriented glass fibers. Beads or fibers of amorphous poly(ethylene terephthalate) (PET) may also be suitable, to the extent that these sorts of beads are generally at least translucent. Generally speaking, particles on the order of about 0.1 to 10 μm may be used, although larger and smaller particles may also be used, depending on the desired visual appearance. One additive that may be particularly suitable is silica, and in particular, fumed silica, which is a pyrogenically-produced amorphous silica in the form of small particles that have a relatively large surface area. These additives may be added, for example, in the range of about 1-10% by weight (w/w). For many additives, including silicas and fumed silicas, the range may be, e.g., 1-5%.

The choice of additive may depend on the material of which the covering 202 is made. If the objective is dispersion of light, it may be helpful in some embodiments if the particles of the additive retain their shape and other characteristics during the molding or other process used to create the covering 202. Thus, it may be helpful if the additive has a higher melting point than the covering 202, so that it retains its individual character during manufacture, instead of melting and mixing with the material of the covering 202. Thus, for example, if the covering 202 is made of a plastic, such as PVC, the additive may be glass or silica. Alternatively, if a resin or plastic material is used as the additive, the additive should have a significantly higher melting point.

Thus, if the covering 202 is made of a plastic resin like PVC, PET, with its much higher melting point, may be a suitable additive. The beads, spheres, or other particles of PET may be completely amorphous, in which case they are more likely to be fully transparent, or they may have some degree of crystallization, in which case they are more likely to be at least somewhat opaque.

Depending on the embodiment, the particles of the additive may all be of the same size, or some particles may be of different sizes. For example, U.S. Pat. No. 6,538,364 to Shaw, the contents of which are incorporated by reference in their entirety, teaches a “bimodal distribution” of particles in conventional coating of a halogen bulb. In the Shaw patent, some of the silica particles used in the coating have a diameter of 0.5-4 μm, while others have a diameter in the range of 10-100 nm. This kind of bimodal size distribution, or even a random distribution of particle sizes, may be used in embodiments of the invention.

As those of skill in the art will realize, including additives of this sort in a plastic will alter the mechanical properties of the material, in some cases creating a composite material with mechanical properties that are different from those of either of the raw materials. For example, the addition of short, randomly-oriented glass fibers (on the order of about 1-2 cm long and 5-20 μm in diameter) has been shown to increase the elastic modulus and strength of some plastics, even in an amount of 10% by weight. Many sources also show that these effects either plateau or drop off at higher concentrations (e.g., beyond 40-50% by weight, or lower, depending on the plastic and the nature of the added fiber). Depending on the embodiment and the intended application of the LED linear lighting 200, an additive like glass fiber may serve as both a dispersion agent and a reinforcing agent. If the additive is to be used as a reinforcing agent as well, the weight percent may be higher than 10%, e.g., 20% or 30%, so long as it does not significantly curtail the light output of the lighting 200. If the covering 202 is intended to be flexible, then the weight percent is preferably not so high as to significantly reduce the flexibility.

Other agents have other effects. For example, fumed silica is known to be a thickening agent, and its presence may increase the viscosity of the covering material in an extrusion. Many other additives may also act as thickeners. In some embodiments, several additives may be used, some in larger quantities primarily for their optical or diffusive effects, and others for their viscosity-modifying, anti-caking, or flow-improving abilities.

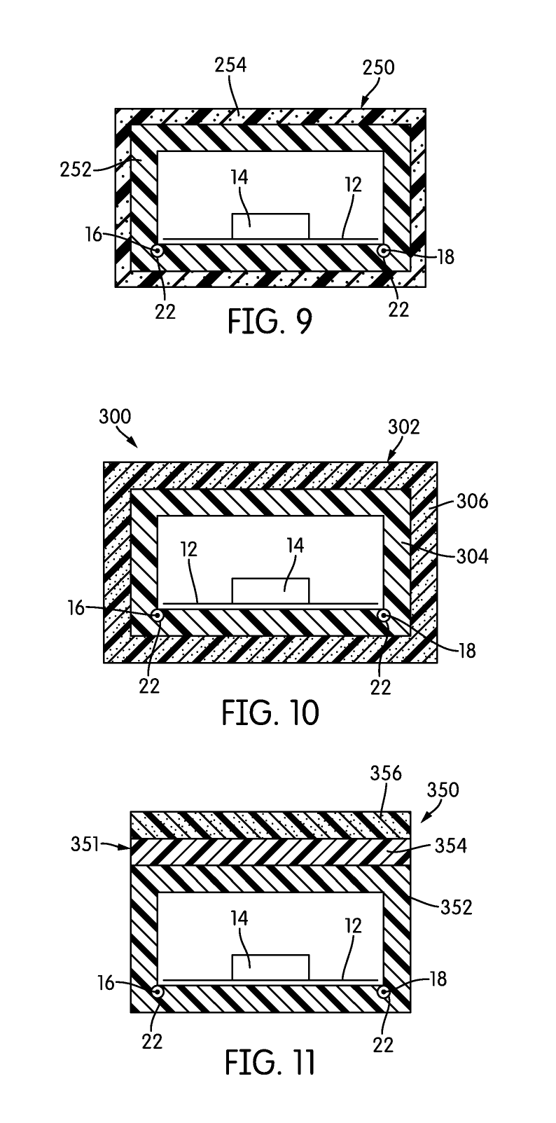

In some cases, it may not be desirable to use an optical modifier that significantly modifies the bulk mechanical properties of the covering 202. If it is not desirable to modify the mechanical properties of the covering material itself, a much thinner coating of the base material with the additive may be added to the exterior of the covering. For example, FIG. 9 is a sectional view similar to the view of FIG. 8, illustrating a piece of linear lighting, generally indicated at 250, according to another embodiment of the invention. The linear lighting 250 has a clear covering 252, made, for example, of PVC or optical silicone, that provides typical, light-transmissive properties and electrical insulation. Overtop the clear covering 252 is a diffusive coating 254 that may be made of the same or different material, with an additive. The diffusive coating 254 may have, e.g., 1-20% of the thickness of the covering 252. Thus, for example, if the covering 252 has a thickness of 2 mm, the coating 254 may have a thickness in the range of 20-200 μm. In some cases, the coating 254 may be considerably thinner, e.g., 5-10 μm. The lower bound of the coating thickness will depend on the size distribution of particles in the coating 254; the matrix of material in the coating 254 should be sufficient to bind the additive particles it carries. There is no particular upper limit to the thickness of the coating 254, save for the consideration that if the coating 254 is provided so that the bulk mechanical properties of the covering 252 are not significantly altered by the presence of the additive, then the coating 254 should be thin enough, relative to the thickness of the covering 252, that it does not significantly alter the mechanical properties of the covering 252. The coating 254, or the material within the covering 202, if a coating 254 is not used, should be sufficiently translucent to allow a significant amount of the light produced by the LED light engines 14 through.

The base material of the coating 254 may be the same as the material of the covering 252, or it may be different. For example, if the covering 252 is made of PVC, the coating 254 may also be made of PVC. However, during the manufacturing process, the viscosity of the carrier used for the coating 254 may be low as compared with that of the covering 252. For example, PVC may be mixed with additives or solvents to lower its viscosity when it is to be used as a coating. Generally speaking, the base material of the coating 254 may be any monomer, polymer, or other substance that is compatible with the material of the covering 252—i.e., any material that will bond with the covering 252.

While co-extrusion, or extrusion over an existing strip of linear lighting 250 with a covering 252, are suitable means of forming the coating 254, because the coating 254 is typically thin compared with the thickness of the covering 252, other methods of coating may be used, including dip coating, spray coating, and other well-known methods. Moreover, while FIG. 9 illustrates the coating 254 applied to all sides of the covering 252, it need not be. In some embodiments, the coating 254 may only be applied on the top face, or on the top face and the side faces.

All other things being equal, a diffuser placed at a greater distance from the light source is usually more effective, because the light rays have more space to spread out before reaching the diffuser. Some embodiments of the invention may use this principle. FIG. 10 is a sectional view of a strip of linear lighting, generally indicated at 300, according to yet another embodiment of the invention. The strip of linear lighting 300 has a coating 302 that, in the illustrated embodiment, is made of two layers, an inner layer 304 and an outer layer 306. The inner layer 304 may be an unmodified, typical layer, e.g., PVC or a similar plastic, approximately 2 mm thick. Thus, light passes normally through the inner layer 304.

The outer layer 306, on the other hand, has diffusing material in it, as described above, or has some other feature that allows it to act as an optical modifier. For example, the outer layer 306 might include silica, glass microspheres, short or long glass fibers, or other such materials. The two layers 304, 306 may be the same thickness, or they may be a different thickness. As compared with the linear lighting 250 of FIG. 9, though, the outer layer 306 is generally thicker than the thin coating 254. The two layers 304, 306 may also have different optical properties. For example, the outer layer 306 may have a greater refractive index than the inner layer 304. The outer layer 306 may be formed simply by extruding over the inner layer 304.

In the linear lighting 300 of FIG. 10, the outer layer 306 fully surrounds the inner layer 304 of the covering 300. However, as with other embodiments, that need not always be the case. FIG. 11 is a sectional view of a strip of linear lighting, generally indicated at 350, according to another embodiment of the invention. The strip of linear lighting 350 has a covering 351 that includes three layers. The innermost layer 352 completely surrounds the PCB 12 and LED light engines 14, providing electrical insulation and a first layer for light from the LED light engines 14 to pass through. The second layer 354 is formed only along the top of the innermost layer, and is provided to increase the distance that the light travels before reaching the outermost layer 356, which is only provided directly atop the second layer 354. The outermost layer 356 has diffusive material in it. In some cases, rather than depositing or extruding a second layer 354 overtop the innermost layer 352, the innermost layer 352 may simply be made thicker. For simplicity in illustration, the three layers 352, 354, 356 are illustrated as having about the same thickness, but they may have different thicknesses in some cases.

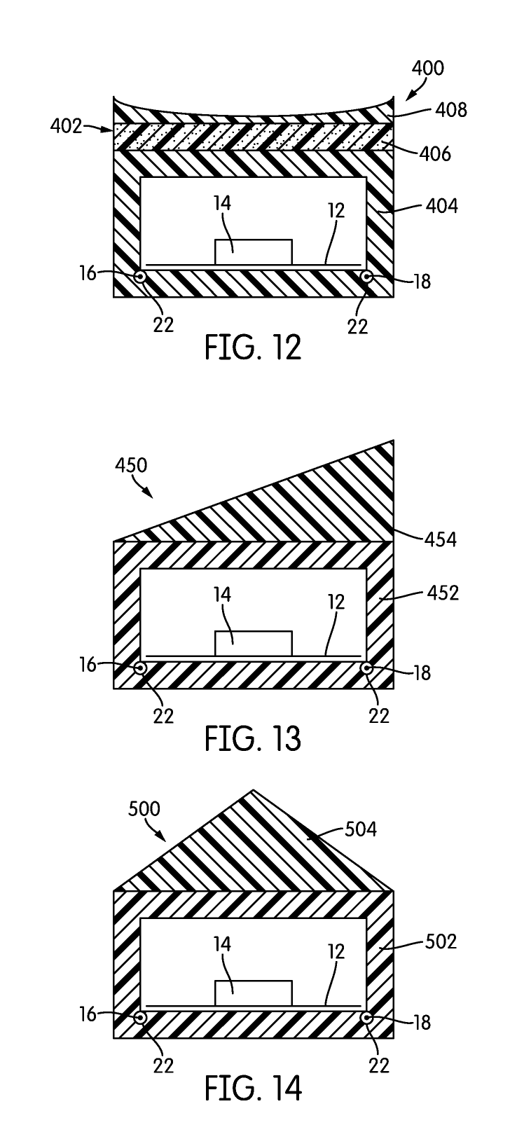

In the above description, the linear lighting is presented as having either lensing or light-diffusing characteristics. In some cases, linear lighting may have both characteristics. As one example of this, FIG. 12 is a sectional view of a strip of linear lighting 400 according to a further embodiment of the invention. The linear lighting 400 has a multi-layered covering 402. The innermost layer 404 of the covering 402 provides electrical insulation. Atop the top face of the innermost layer 404, a second layer 406 is provided. The second layer 406 has diffusive material in it. Overtop the second layer, a third layer 408 forms a plano-concave lens. Thus, in this embodiment, light generated by the LED light engines 14 passes through the innermost layer 404 directly through a layer 406 that diffuses it, then through a diverging lens 408. The two outer layers 406, 408 may be extruded over the basic covering 404, and may be made of the same material or different materials. While the diffusing layer 406 is shown to be the same thickness as the other layers 404, 408 in FIG. 12, it may be significantly thinner, like the coating 254 of FIG. 9 above. As was described above, the thickness of the lens 408 and its other characteristics may be determined using standard equations. Of course, this is but one example of combining diffusing and lensing effects—many other combinations are possible.

The covering of LED linear lighting may be given other types of light-modifying properties. For example, in some cases, it may be helpful to direct the light in a certain direction at the level of the covering. FIG. 13 is a sectional view of linear lighting 450, illustrating one way in which this might be done. The linear lighting 450 has a covering 452 that has a hollow, rectangular cross-section and is made of a transparent plastic, like PVC, similar to the covering of other embodiments. However, atop a standard covering 452, a prism 454 is formed. The prism 454 may be made of the same material of which the covering 452 is made, or it may be made of a different material, e.g., a material with a different refractive index. As with other features of this type, the prism 454 may be co-extruded with or extruded over the covering 452, or it may be formed separately and attached by adhesives, fusing, or some other appropriate means. Moreover, although shown in FIG. 13 as a separate layer from the covering 452, in some cases, the prism 454 may simply be an integral part of the covering 452, i.e., the cross-sectional shape shown in FIG. 13 is extruded in a single piece. The direction, orientation, and angle(s) of the prism 454 may vary from embodiment to embodiment.

The prism 454 is a single prism, and its features may be chosen to direct the light wherever needed. The prism 454 of FIG. 13 forms a scalene right triangular prism, with the short leg extending straight up and coinciding with the side of the covering 452. While FIG. 13 illustrates the prism 454 extending generally in a first direction, it may extend in the other direction.

FIG. 14 is a sectional view of a strip of linear lighting, generally indicated at 500, with a covering 502. Atop the covering 502, a prism 504 is provided. The prism 504 is an isosceles triangular prism, with two angled faces of the same length that meet at a central angle approximately over the middle of the PCB 12. Generally speaking, prisms 454, 504 will change the direction of at least some of the exiting rays of light relative to a typical covering. In some instances, depending on the angles of incidence of the light rays, the angles of the prism 454, 504 and the critical angle of the material of which the prism 454, 504 is made, some rays of light may undergo total internal reflection, which usually means that they re-enter the linear lighting 450, 452, are reflected off the components, and exit by another path. This effect may be useful in diffusing the light, and internal components, including the PCB 12 and LED light engines 14 may be given a white coating or color to aid in reflection of light rays.

While the prisms 454, 504 illustrated here are on the outside of their respective coverings 452, 502, they could be provided on the interior of the coverings in some cases, much like the lens of FIG. 5.

In this description and in the claims, unless prismatic effects, changes in the direction of light rays, or directionality are mentioned or enumerated separately, the terms “lensing” and “lensing effects” should be construed to include them, even though a prism is not a lens per se.

While the invention has been described with respect to certain embodiments, the description is intended to be exemplary, rather than limiting. Modifications and changes may be made within the scope of the invention, which is defined by the appended claims.

1. Linear lighting, comprising:
an elongate, flexible printed circuit board (PCB);
a plurality of light-emitting diode (LED) light engines disposed on and connected to the PCB; and
a translucent or transparent flexible covering surrounding the PCB, an entire surface of the covering through which light from the LED light engines is transmitted having roughening to diffuse the light.

2.-10. (canceled)

11. The linear lighting of claim 1, wherein the roughening comprises a first regular pattern formed in the surface of the covering.

12. The linear lighting of claim 11, wherein the first pattern extends in a first direction and the linear lighting further comprises second roughening including a second regular pattern formed in a second surface of the covering, the second pattern extending in a different direction along the linear lighting than the first pattern.

13. The linear lighting of claim 1, wherein the roughening comprises mechanical abrasion.

14.-29. (canceled)

30. The linear lighting of claim 11, wherein the first pattern comprises a sawtooth pattern.

31. The linear lighting of claim 11, wherein the first pattern comprises a pyramidal pattern.

32. The linear lighting of claim 1, wherein the covering comprises PVC.

33. Linear lighting, comprising:
an elongate, flexible printed circuit board (PCB);
a plurality of light-emitting diode (LED) light engines disposed on and connected to the PCB; and
an elongate, flexible, translucent or transparent polymer covering with a generally rectilinear exterior shape surrounding the PCB, the covering having a first side through which light emitted by the LED light engines passes, at least one surface of the first side of the covering having a regular pattern formed thereon.

34. The linear lighting of claim 33, wherein the pattern comprises a sawtooth pattern.

35. The linear lighting of claim 34, wherein the sawtooth pattern extends longitudinally, along a length of the covering.

36. The linear lighting of claim 34, wherein the sawtooth pattern extends transversely, along a width of the covering.

37. The linear lighting of claim 33, wherein the pattern comprises a pyramidal pattern.

38. The linear lighting of claim 33, further comprising a second pattern formed on a second surface of the first side.

39. The linear lighting of claim 38, wherein the first pattern runs in a first direction and the second pattern runs in a second direction.

40. The linear lighting of claim 39, wherein the first pattern and the second pattern are sawtooth patterns.

41. The linear lighting of claim 33, wherein the covering comprises PVC.

42. The linear lighting of claim 33, wherein the covering has a generally rectilinear interior shape.

43. The linear lighting of claim 33, wherein the entire surface of the first side of the covering has the pattern.
